(19) United States
(12) Patent Application Publication
(10) Pub. No.: US 2009/0084776 A1
(43) Pub. Date: Apr. 2, 2009

(54) INDUCTION DEVICE FOR A HUMIDIFIER

(76) Inventors: Chuan-Pan Huang, Tainan City (TW); Chen-Lung Huang, Tainan City (TW)

Correspondence Address: J.C. Patents, 4 Venture, Suite 250, Irvine, CA, 92618, US

(21) Appl. No.: 11/866,217

(22) Filed: Oct. 2, 2007

(51) Int. Cl. H05B 6/08

(52) U.S. Cl. 219/665

(57) ABSTRACT

An induction device for a humidifier includes an backward wave oscillating circuit an emitting induction coil connected to the backward wave oscillating circuit and a control circuit composed of a rectifying filtering circuit, a transmit control circuit and a receiving induction coil and a function unit. The emitting induction coil and the receiving induction coil are positioned very near for effectively interacting to each other so that the control circuit may be activated to work by the voltage generated at two terminals of the receiving induction coil to permit the humidifier function. The function unit is a decorative element. The receiving induction coil receives the electromagnetic field generated by the emitting induction coil, so voltage can be generated at two terminals of the receiving induction coil for driving the control circuit.

### BACKGROUND OF THE INVENTION

1. Field of the Invention

This invention relates to an induction device for a humidifier, particularly to one provided with a backward wave oscillation circuit, an emitting induction coil connected to the backward wave oscillating circuit and positioned in the interior or the exterior of a base of a humidifier, and a control circuit consisting of a rectifying filtering circuit, a transmit control circuit, a function unit and a receiving induction coil. The receiving induction coil receives the electromagnetic field generated by the emitting induction coil, so the voltage generated at two terminals of the receiving induction coil may drive the control circuit to work.

2. Description of the Prior Art

A conventional humidifier has an excessively complicated structure with an electric decorative pattern or with a decorative lamp set at the outlet of a fog generating tank, or a decorative lamp set on the fog generating tank, as it involves a control circuit connected to the pattern or the decorative lamp with wires.

### SUMMARY OF THE INVENTION

This invention has been devised to offer an induction device for a humidifier, to make the humidifier very safe and convenient to use.

The invention has an emitting induction coil provided in a base of a humidifier, and a receiving induction coil of a control circuit positioned very near the emitting induction coil, so the receiving induction coil may receive the electromagnetic field generated by the emitting induction coil, so the voltage generated at the two terminals of the receiving induction coil can drive the control circuit to let the humidifier to work.

The invention has the following features:

1. The base is provided with the backward wave oscillating circuit, and the emitting induction coil connected with the backward wave oscillating circuit, which is installed in the interior or the exterior of the base.

2. The control circuit is composed of a rectifying filtering circuit, a transmitting control circuit, a function unit and a receiving induction coil. The receiving induction coil is positioned in an exterior of the base.

3. The receiving induction coil receives an electromagnetic field from the emitting induction coil, so voltage generated at two terminals of the receiving coil can drive the control circuit to let the humidifier to work.

### BRIEF DESCRIPTION OF DRAWINGS

This invention will be better understood by referring o the accompanying drawings, wherein:

FIG. 1 is a partial cross-sectional view of a first preferred embodiment of an induction device for a humidifier in the present invention;

FIG. 2 is a partial cross-sectional view of a second preferred embodiment of an induction device for a humidifier in the present invention;

FIG. 3 is a block diagram of a backward wave oscillating circuit in the present invention;

FIG. 4 is a block diagram of a control circuit in the present invention;

FIG. 5 is a partial cross-sectional view of a third preferred embodiment of an induction device for a humidifier in the present invention; and,

FIG. 6 is a partial cross-sectional view of a fourth preferred embodiment of an induction device for a humidifier in the present invention.

### DETAILED DESCRIPTION OF THE PREFERRED EMBODIMENTS

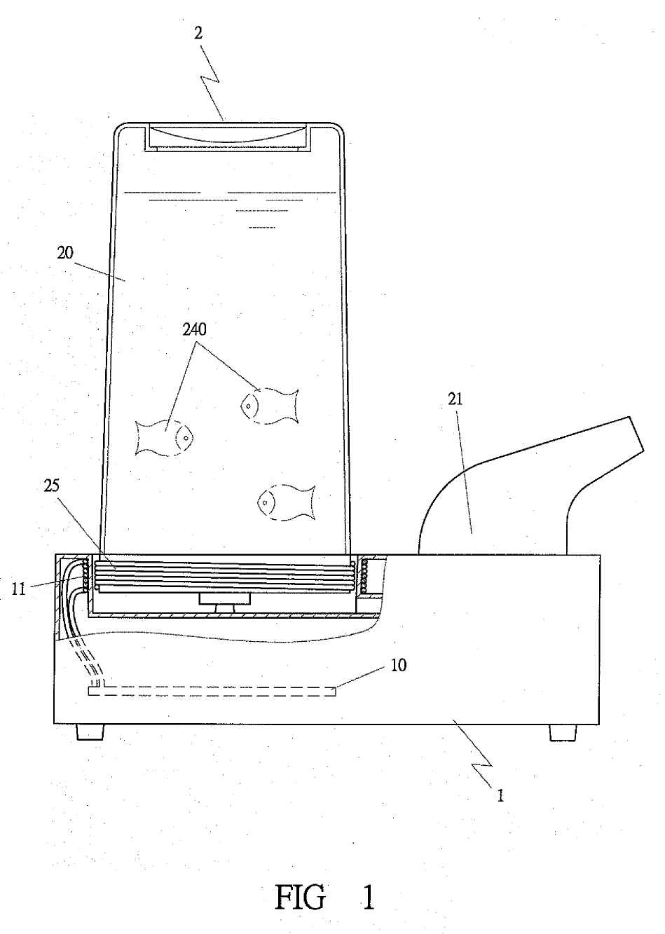

A first preferred embodiment of an induction device for a humidifier in the present invention, as shown in FIG. 1, includes, a backward wave oscillating circuit 10, an emitting induction coil 11, a control circuit 2 composed of a rectifying filtering circuit 22, a transmit control circuit 23, a function unit 24 and a receiving induction coil 25.

The backward wave oscillating circuit 10 is installed in a base 1 of a humidifier and connected with the emitting induction coil II that is set in the base I at a proper location for easily interacting with the receiving induction coil 25 installed under a water tank 20 of the humidifier and on one side of the base 1, as shown in FIG. 1. The receiving induction coil 25 is positioned under the water tank 20 and on the base 1, and a fog generating tank 21 of the humidifier is positioned on the other side of the base 1 and beside the water tank 20. The rectifying filtering circuit 22 and the transmitting control circuit 23 are positioned in a center space of the receiving induction coil 25.

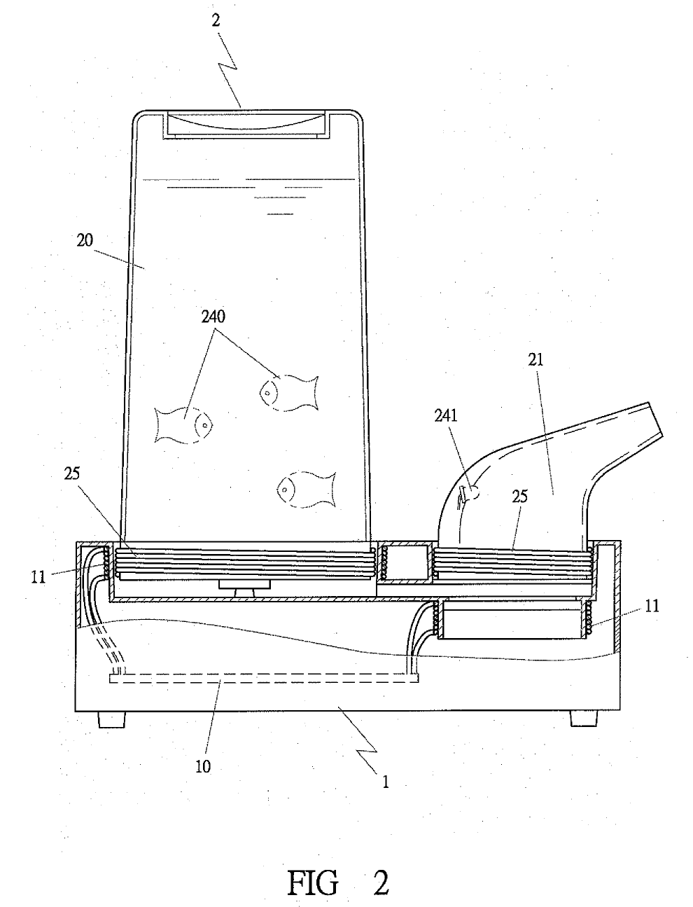

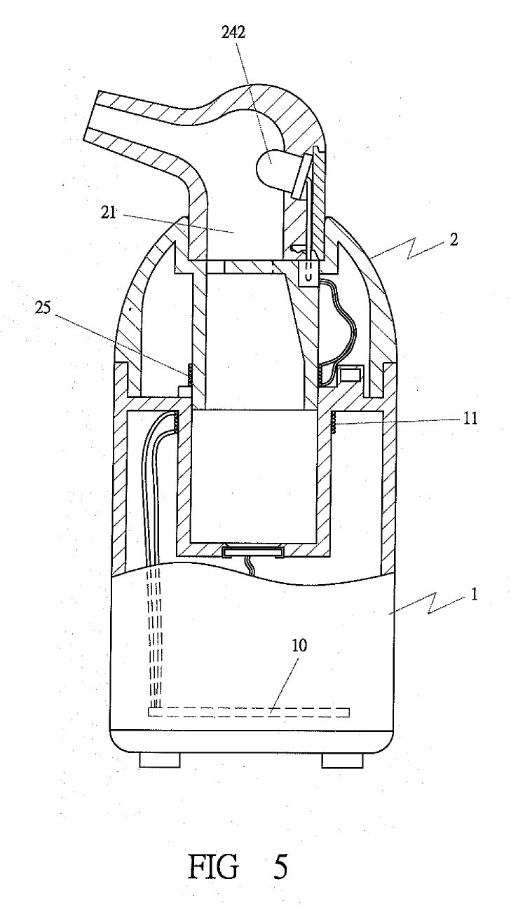

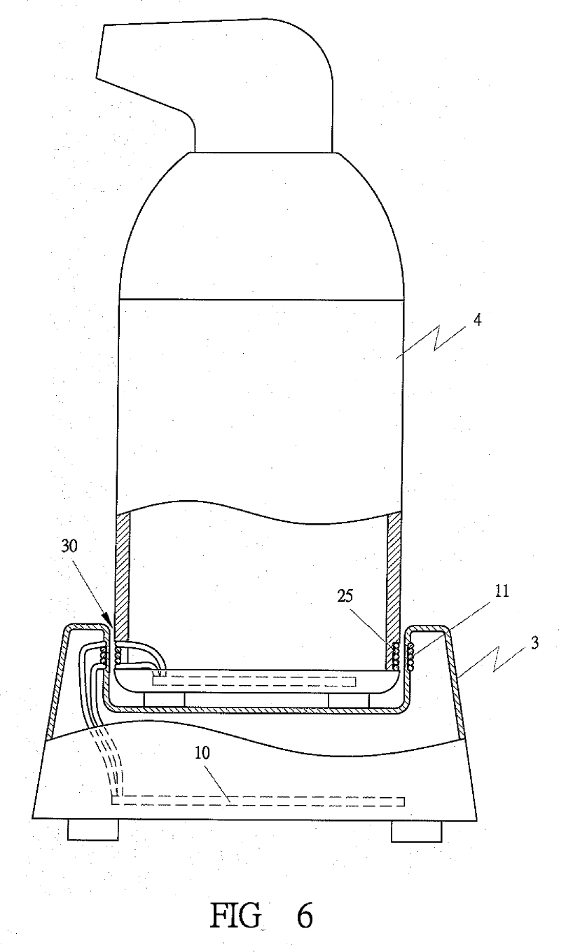

The function unit 24 is plural decorative patterns 240 formed in the water tank 20 and electrically connected as shown in FIG. 1, or a decorative lamp 241 set at an exit of the fog generating tank 21 shown in FIG. 2 illustrating a second embodiment of the invention, or a decorative lamp 242 set in the fog generating tank 21 as shown in FIG. 5 illustrating a third embodiment of the invention, for the purpose of beautifying the humidifier.

The rectifying filtering circuit 22 and the transmitting control circuit 23 and the receiving induction coil 25 do not need wires for connecting to the power, and the backward wave oscillating circuit 10 is to be connected to the power and to be turned on and off via a switch. The receiving induction coil 25 is to be positioned very near the emitting induction coil 11 for convenience to interact with each other, so as to receive the maximum electromagnetic field from the emitting induction coil 11 for good conductivity without need of any wires for connection to power, boosting the safety of the humidifier in use.

Next, the emitting induction coil 11 is positioned around closely the receiving induction coil 25 as shown in FIG. 1 showing the first preferred embodiment, or with two pairs of the emitting induction coils 11 and the receiving induction coils 25, one pair positioned under the water tank 20 and the other pair positioned under the fog generating tank 21 as shown in FIG. 2 showing the second preferred embodiment. However, their position is not limited as the two ways in the first and the second preferred embodiments just mentioned as long as the receiving induction coil 25 can easily receive the electromagnetic field from the emitting induction coil 11.

A second preferred embodiment of a induction device for a humidifier in the invention has almost the same structure of the first one, except that another receiving induction coil 25 is additionally provided under the fog generating tank 21, and another emitting induction coil 11 is additionally provided in the base 1 just under the receiving induction coil 25 for strengthening interaction of the both coils 25 and 11.

Next, FIG. 5 shows a third preferred embodiment of an induction device for a humidifier in the invention, which includes a backward wave oscillating circuit 10 installed in a lower body 1 of a humidifier shaped as a large cup and formed with a small water tank in an upper portion, and then an upper body 2 closed on the lower body 1 and provided with an annular wall extending down in the center portion. An emitting induction coil 11 is fixed around an upper end of the small water tank 20 and a rectifying filtering circuit 22 and a transmitting control circuit 23 both fixed on the inner wall or the outer wall of the annular wall of the upper body 2, and a receiving induction coil 25 wound around a lower portion of the annular wall only a little above the emitting induction coil 11 that is wound around an upper end of the small water tank 20 for interacting with each other. Then the receiving induction coil 25 receives an electromagnetic field from the emitting induction coil 11 so that voltage is generated at two terminals of the receiving induction coil 25 to activate the control circuit 2 to work.

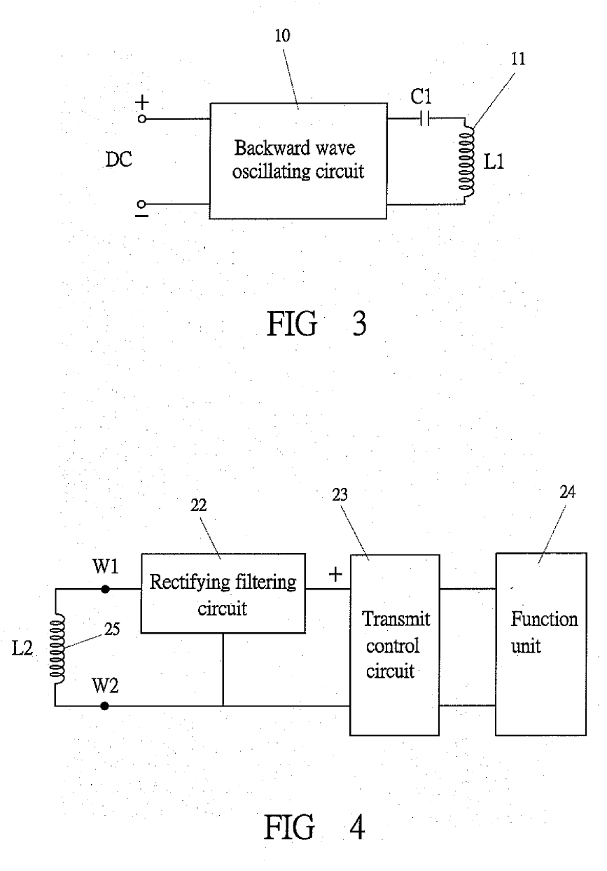

Moreover, FIG. 6 shows a fourth preferred embodiment of an induction device for a humidifier, including a base 3 of a humidifier body 4, as shown in FIG. 3, a backward wave oscillating circuit 10 installed in the base 3, an emitting induction coil 11 wound around an annular wall of a recess 30 formed in an upper portion of the base 3 and connected to the backward wave oscillating circuit 10, a rectifying filtering circuit 22, and a transmit control circuit 23 both fixed under the water tank 20, and a receiving induction coil 25 wound around an lower end of the water tank 20 facing to the emitting induction coil 1 I for the most effective interaction of the two induction coils 11 and 25. A function unit 24 is a decorative lamp positioned in a fog generating tank 21 of a humidifier.

Then in the fourth preferred embodiment, the receiving induction coil 25 receives an electromagnetic field from the emitting induction coil 11, and the voltage generated at two terminals of the receiving induction coil 25 can drive the control circuit 2 to work, in the same way of the other preferred embodiments.

While the preferred embodiments of the invention have been described above, it will be recognized and understood that various modifications may be made therein and the appended claims are intended to cover all the modifications that may fall within the spirit and scope of the invention.

What is claimed is:

1. An induction device for a humidifier comprising:
a base of a humidifier:
a backward wave oscillating circuit installed in said base;
an emitting induction coil fixed in said base and connected with said backward wave oscillating circuit;
a control circuit composed of a rectifying filtering circuit, a transmitting control circuit, a function unit and a receiving induction coil, said receiving induction coil installed on said base for receiving an electro-magnetic field generated by said emitting induction coil, voltage generated at two terminals of said receiving induction coil, said voltage driving said control circuit to work.

2. The induction device for a humidifier as claimed in claim 1, wherein said function unit provided in said control circuit is a decorative pattern formed on a water tank of a humidifier.

3. The induction device for a humidifier as claimed in claim 1, wherein said function unit provided in said control circuit is a decorative lamp set at an exit of a fog generating tank of a humidifier.

4. The induction device for a humidifier as claimed in claim 1, wherein said function unit of said control circuit is a decorative lamp set in said fog generating tank of a humidifier.

5. An induction device for a humidifier comprising:
a base of a humidifier;
a backward wave oscillating circuit laid in said base;
an emitting induction coil fixed in said base and connected to said backward wave oscillating circuit;
a control circuit composed of a rectifying filtering circuit, a transmitting control circuit a function unit and a receiving induction coil, said induction coil fixed on said base for receiving an electromagnetic field from said emitting induction coil, voltage generated at two terminals of said receiving induction coil, said voltage driving said control circuit to work.

6. The induction device for a humidifier as claimed in claim 1, wherein said emitting induction coil is located adjacent to said receiving induction coil.

7. The induction device for a humidifier as claimed in claim 5, wherein said emitting induction coil is located adjacent to said receiving induction coil.
